(19) United States
(12) Patent Application Publication
(10) Pub. No.: US 2026/0179894 A1
(43) Pub. Date: Jun. 25, 2026

(54) Systems And Methods Of Error-Tolerant Real-Time Searching

(71) Applicant: Thermo Finnigan LLC, San Jose, CA (US)

(72) Inventors: Graeme McAlister, San Jose, CA (US); Jesse D. Canterbury, Shoreline, WA (US); William Barshop, San Jose, CA (US); Lilian Heil, Mountain View, CA (US)

(21) Appl. No.: 18/987,376

(22) Filed: Dec. 19, 2024

(51) Int. Cl. H01J 49/00

(52) U.S. Cl. CPC H01J 49/004; H01J 49/0036

(57) ABSTRACT

Disclosed herein is a method of analyzing a sample by mass spectrometry. A precursor is acquired from the sample. At least one mass spectrum associated with the precursor is generated based on performing a first level of analysis on the precursor. At least one motif in the precursor is identified based on performing a real-time error-tolerant search of the at least one mass spectrum using stored mass spectral reference data. Based on identifying the at least one motif in the precursor, at least one second level of analysis on the at least one motif is initiated to determine an identity of the precursor.

### BACKGROUND

Analyzing a sample by mass spectrometry can include performing a real-time search that correlates absolute m/z measurements associated with the sample against theoretical and/or expected m/z values. The theoretical and/or expected values can be derived from either a database or a library provided by a user. However, these real-time database searches and real-time library searches are restricted to only searching for matches in the database or the library provided by the user. Accordingly, there is a long-felt need in the art for improved mass spectrometry systems and methods.

### SUMMARY

In meeting the described needs, the present disclosure first provides a method of analyzing a sample by mass spectrometry, comprising: acquiring a precursor from the sample; generating at least one mass spectrum associated with the precursor based on performing a first level of analysis on the precursor; identifying at least one motif in the precursor based on performing a real-time error-tolerant search of the at least one mass spectrum using stored mass spectral reference data; and based on identifying the at least one motif in the precursor, initiating at least one second level of analysis on the at least one motif to determine an identity of the precursor.

Also provided is a mass spectrometry device, comprising: one or more processors; and memory storing instructions that, when executed by the one or more processors, cause the mass spectrometry device to: acquire a precursor from a sample; generate at least one mass spectrum associated with the precursor based on performing a first level of analysis on the precursor; identify at least one motif in the precursor based on performing a real-time error-tolerant search of the at least one mass spectrum using stored mass spectral reference data; and based on identifying the at least one motif in the precursor, initiate at least one second level of analysis on the at least one motif to determine an identity of the precursor.

Also provided is a computer-readable medium storing instructions that, when executed, cause: acquiring a precursor from a sample; generating at least one mass spectrum associated with the precursor based on performing a first level of analysis on the precursor; identifying at least one motif in the precursor based on performing a real-time error-tolerant search of the at least one mass spectrum using stored mass spectral reference data; and based on identifying the at least one motif in the precursor, initiating at least one second level of analysis on the at least one motif to determine an identity of the precursor.

### BRIEF DESCRIPTION OF THE DRAWINGS

Embodiments will be readily understood by the following detailed description in ‎conjunction with the accompanying drawings. To facilitate this description, like reference ‎numerals designate like structural elements. Embodiments are illustrated by way of ‎example, not by way of limitation, in the figures of the accompanying drawings.‎

FIG. 1 shows an example system for mass spectrometry analysis using real-time error-tolerant searching, in accordance with various embodiments.

FIG. 2 shows an example first level of mass spectrometry analysis, in accordance with various embodiments.

FIG. 3 is a flow diagram of an example method of mass spectrometry analysis using real-time error-tolerant searching, in accordance with various embodiments.

FIG. 4 is a flow diagram of an example method of mass spectrometry analysis using real-time error-tolerant searching, in accordance with various embodiments.

FIG. 5 is an example computing device, in accordance with various embodiments.

### DETAILED DESCRIPTION

Disclosed herein is a method of analyzing a sample by mass spectrometry, as well as related devices, systems, and computer-readable mediums. In some embodiments, the method disclosed herein facilitates real-time, error-tolerant searching that allows for a more open-ended analysis of mass spectra. For example, the method disclosed herein facilitates real-time searching that is not restricted to only searching for matches in a database or a library provided by a user.

A precursor can be acquired from the sample. It can be unknown how the precursor relates to all of the potential precursors that can be in the sample. An initial level of analysis can be performed to identify one or more known motifs in the precursor. The known motif(s) can include, for example, one or more sequence or structural motifs. To identify the known motif(s) in the precursor, one or more mass spectra associated with the precursor can be generated by performing a MS1 and/or an MS2 scan on the precursor. The known motif(s) can be identified by performing a real-time error-tolerant search of at least one of the mass spectra using stored mass spectral reference data. The mass spectral reference data can be stored, for example, in a database of references that is generated in silico and/or in a library of references that contains a collection of experimental spectra.

The identification of the known motif(s) in the precursor can trigger an additional level of analysis, such as the performance of one or more additional MS2 scans, an MS3 scan, and/or an MS4 scan. While these additional MS scans can provide valuable layers of information for identifying the precursor, they also can significantly slow down the mass spectrometry instrument. Thus, the additional level of analysis can be performed only on the known motif(s), instead of on the entire precursor, thereby enabling a high confidence identification of the precursor while also reducing the overall run time for the mass spectrometry analysis. This reduction in run time can be especially valuable given a fixed analysis time.

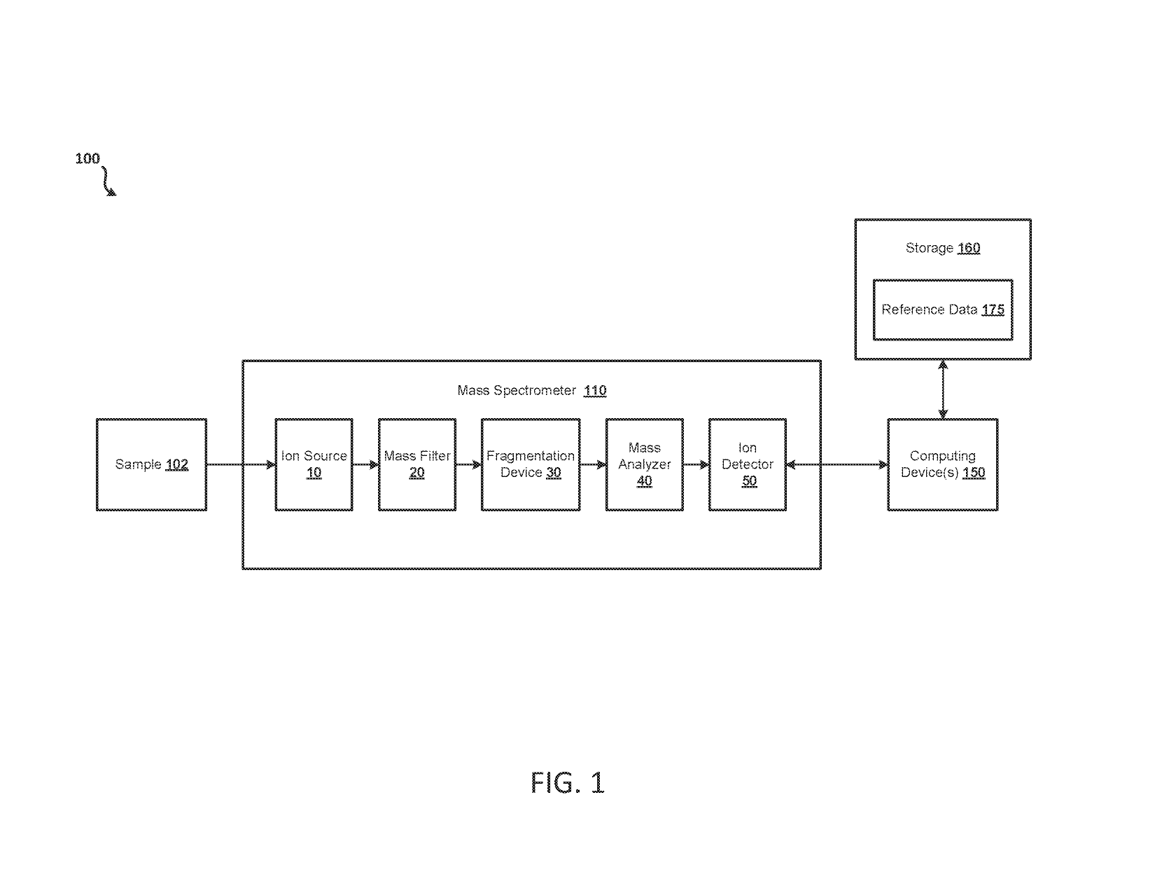

FIG. 1 shows an exemplary system 100 for mass spectrometry analysis. The exemplary system 100 includes mass spectrometer 110 having a connected computer system 150 for evaluating the accruing data. The computer system 150 can be configured to control the operation of the mass spectrometer 110 .

The mass spectrometer 110 can include an ion source 10. The ion source 10 can be configured to generate ions from a sample 102. The sample 102 can be loaded into the mass spectrometer 110 in liquid, gas or dried form and then vaporized and ionized by the ion source 10. The ion source 10 can be any suitable continuous or pulsed ion source, such as an electrospray ionization (ESI) ion source, a MALDI ion source, and atmospheric pressure ionization (API) ion source, a plasma ion source, an electron ionization ion source, a chemical ionization ion source, and so on. More than one ion source 10 can be provided and used. The ions can be any suitable type of ions to be analyzed, including small organic molecules, large organic molecules, biomolecules, DNA, RNA, proteins, peptides, fragments thereof, and/or the like.

A mass filter 20 can be arranged downstream of the ion source 10. The mass filter 20 can be configured to receive ions from the ion source 10. The mass filter 20 can be configured to filter received ions according to their mass to charge ratio (m/z), e.g., such that only ions within a m/z window are onwardly transmitted by the mass filter 20, while ions outside of the mass filter's m/z window are rejected by the mass filter 20 and are not onwardly transmitted. The m/z width and the center m/z of the mass filter's transmission window can be controllable (variable), e.g., by suitable control of RF and DC voltages applied to the mass filter 20. Thus, for example, the mass filter can be operable in a transmission mode of operation, whereby most or all ions within a relatively wide m/z window are onwardly transmitted by the mass filter 20, and a filtering mode of operation, whereby only ions within a relatively narrow m/z window (centered at a desired m/z) are onwardly transmitted by the mass filter 20. The mass filter 20 can be any suitable type of mass filter, such as a quadrupole mass filter.

The fragmentation device 30 is arranged downstream of the mass filter 20. The fragmentation device 30 can be configured to receive most or all ions transmitted by the mass filter 20. The fragmentation device 30 can be configured to selectively fragment some or all of the received ions, i.e., so as to produce fragment ions. The fragmentation device 30 can be operable in a fragmentation mode of operation, whereby most or all received ions are fragmented so as to produce fragment ions (which can then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 can also be operable in one or more intermediate modes of operation, e.g., whereby the degree of fragmentation is controllable (variable). The fragmentation device 30 can also be operable in higher order (MS^{N}) fragmentation modes of operation, e.g., whereby fragment ions are further fragmented one or more times by the fragmentation device 30.

The fragmentation device 30 can be any suitable type of fragmentation device that can be used to fragment labelled analyte ions to produce analyte fragment ions and reporter ions or complementary ions, such as for example a collision induced dissociation (CID) fragmentation device, an electron induced dissociation (EID) fragmentation device, a photodissociation fragmentation device, and so on. Numerous other types of fragmentation are possible and are within the scope of the present disclosure.

The mass analyzer 40 can be arranged downstream of the fragmentation device 30. The mass analyzer 40 can be configured to receive most or all ions onwardly transmitted from the fragmentation device 30. The mass analyzer 40 can alternatively receive ions from the mass filter 20, e.g., if the instrument is configured such that in the non-fragmentation mode of operation ions are caused to bypass the fragmentation device 30. Thus, in general, the mass analyzer 40 can be configured to receive ions from the various upstream stages of the instrument, which can include unfragmented (“precursor” or “parent”) ions, fragment (“product” or “daughter”) ions, fragmented fragment (“granddaughter”) ions, and so on.

The mass analyzer 40 can be configured to analyze the ions so as to determine their mass to charge ratio and/or mass, i.e., to produce a mass spectrum of the ions. For example, the mass analyzer 40 can separate the ions by mass and charge via electromagnetic deflection. The ions that are properly aligned, i.e., successfully deflected by the mass analyzer 40, can be detected by the ion detector 50. This entire process can be performed under an comparatively high vacuum (10⁻⁶ to 10⁻⁸ torr) to remove gas molecules and neutral and contaminating non-sample ions, which can collide with sample ions and alter their paths or produce non-specific reaction products.

The mass analyzer 40 can be any suitable mass analyzer. The mass analyzer 40 can be, for example, an ion trap mass analyzer, such as an electrostatic orbital trap. Alternatively, the mass analyzer 40 can be a time-of-flight (ToF) mass analyzer, such as a multi-reflecting time-of-flight mass analyzer.

The mass spectra arising on the ion detector 50 can be processed and conditioned by the computer system 150. The computer system 150 can be configured to perform a real-time error-tolerant search of the mass spectra using mass spectral reference data 175 stored in a storage 160. The storage 160 can include, for example, a database of references that is generated in silico and/or a library of references that contains a collection of experimental spectra. The computer system 150 can be configured to perform the real-time error-tolerant search of the mass spectra by comparing the mass spectra to the stored mass spectral reference data 175. By performing the real-time error-tolerant search of the mass spectra, the computer system 150 can determine an identify of the ions detected by the ion detector 50.

The mass spectrometer 110 can be operable in various modes of operation, including an MS1 mode of operation, an MS2 mode of operation, and/or one or more higher order fragmentation (MS^{N}) modes of operation, such as for example an MS3 or MS4 mode of operation.

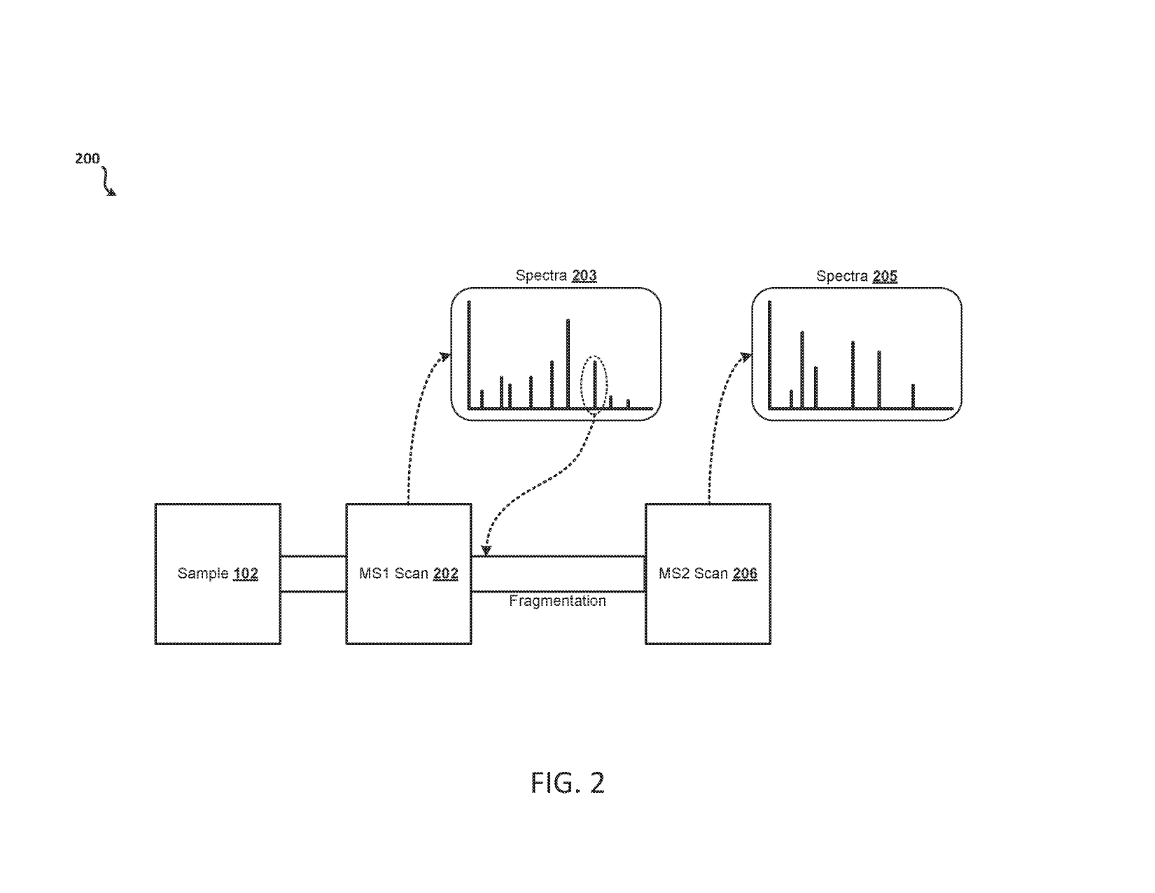

In embodiments, mass spectrometer 110 can be configured to perform a first level of analysis on the sample 102. An example first level of analysis 200 is shown in FIG. 2. The first level of analysis 200 can include an MS1 scan 202 and an MS2 scan 206. To perform the MS1 scan 202, the mass spectrometer 110 can be operated in the MS1 mode of operation. In the MS1 (or “full mass scan”) mode of operation, the mass filter 20 can be operated in a transmission mode of operation and the fragmentation device 30 can be operated in a non-fragmentation mode of operation, e.g., so that a relatively wide m/z range (e.g., full mass range) of unfragmented (“precursor” or “parent”) ions are analyzed by the mass analyzer 40. The mass analyzer 40 can analyze the precursor ions so as to determine their mass to charge ratio and/or mass, i.e., to generate a mass spectra 203 representative of the precursor ions. For example, to generate the mass spectra 203, the mass analyzer 40 can separate the precursor ions by mass and charge via electromagnetic deflection.

Ions from the mass spectra 203 can then be selectively fragmented and analyzed by a second stage of mass spectrometry (MS2) to generate the spectra 205 for the ion fragments. To perform the MS2 scan 206, the mass spectrometer 110 can be operated in the MS2 mode of operation. In the MS2 mode of operation, the mass filter 20 can be operated in its filtering mode of operation and the fragmentation device 30 can be operated in its fragmentation mode of operation, e.g., so that a selected narrow m/z range of precursor ions are fragmented, and the resulting fragment (“product” or “daughter”) ions are analyzed by the mass analyzer 40. To fragment the selected narrow m/z range of precursor ions, the fragmentation device 30 can perform, for example, collisionally-induced fragmentation, such as collision-induced dissociation (CID) or higher-energy collisional dissociation (HCD).

In the MS2 mode of operation, the center of the mass filter's (narrow) m/z window can be sequentially altered between each of a plurality of different m/z values, e.g., so as to sequentially select (and fragment) each of a plurality of different precursor ions with respective different m/z. In a data dependent acquisition (DDA) MS2 mode of operation, the plurality of different m/z values can correspond to a plurality of different precursor ions identified from corresponding MS1 data (i.e., a full mass scan). In a data independent acquisition (DIA) MS2 mode of operation, the plurality of different m/z values can be taken from a predetermined (fixed) list, i.e., without reference to MS1 data.

The mass analyzer 40 can analyze the fragmented ions so as to determine their mass to charge ratio and/or mass, i.e., to generate the mass spectra 205 representative of the fragmented ions. For example, to generate the mass spectra 205, the mass analyzer 40 can separate the fragmented ions by mass and charge via electromagnetic deflection.

The mass spectra 205 arising on the ion detector 50 can be processed and conditioned by the computer system 150. The computer system 150 can identify at least one known motif in the precursor ions based on performing a real-time error-tolerant search of the mass spectra 205. The computer system 150 can perform the real-time error-tolerant search of the mass spectra 205 using the stored mass spectral reference data 175. The computer system 150 can be configured to perform the real-time error-tolerant search of the mass spectra 205 by comparing the mass spectra 205 to the stored mass spectral reference data 175.

In aspects, given the time constraints involved with real-time searching, and the search space explosion often encountered with error-tolerant searching, the mass spectra 205 can be transformed into a spectrum of mass differences, where every pair of fragment ions can be reduced to a single peak defined by the mass difference between the fragment ions in the pair and the intensity of the two fragment ions. The fragment ions of the theoretical and/or database spectra in the stored mass spectral reference data 175 can be treated similarly. Further, the mass difference spectrum of the theoretical and/or database spectra in the stored mass spectral reference data 175 can be indexed to allow fast correlation between the observed fragment mass differences with theoretical mass differences. Performing the real-time error-tolerant search of the mass spectra 205 can include comparing the spectrum of mass differences to the indexed mass spectral data. This fragment mass differencing can expediently reduce the size of the error-tolerant search space.

The identification of the known motif(s) in the precursor ions can trigger a second level of analysis. The second level of analysis can be performed to determine an identity of the precursor ions. The second level of analysis can include an additional MS2 scan. The additional MS2 scan can utilize any one or more of electron-mediated dissociation, proton-mediated dissociation, molecule-mediated dissociation, or photon-mediated dissociation. The additional MS2 scan can utilize any one or more of electron-transfer dissociation (ETD), proton transfer reaction (PTR), ultraviolet photodissociation (UVPD), or infrared multiple photon dissociation (IRMPD). The second level of analysis can additionally, or alternatively, include an MS3 scan, an MS4 scan, or a scan at any other higher level N of MS^{N}. The second level of analysis can be performed by the mass spectrometer 110 operated in one or more higher order fragmentation (MS^{N}) modes of operation, such as for example an MS3, MS4, or higher mode of operation. Alternatively, the second level of analysis can be performed by any other suitable device or system.

While these additional MS scans can provide valuable layers of information for identifying the precursor ions, they also can significantly slow down the mass spectrometer 110. By performing the second level of analysis only on the identified known motif(s), instead of on all of the precursor ions, the precursor ions can still be identified with a high confidence, while also reducing the overall run time for the mass spectrometry analysis. This reduction in run time can be especially valuable given a fixed analysis time.

In some aspects, the techniques described above can be used to identify “classes” of peptides as they elute into the mass spectrometer 110 by looking for conserved sequences and motifs within the larger intact ion. A somewhat simplistic example of this workflow could entail searching for phosphopeptides, which have a fairly conserved phosphate neutral loss pattern. The absolute m/z placement of this neutral loss pattern is determined by the precursor m/z. But that absolute m/z position is not relevant when performing an error-tolerant search like one of the ones detailed above. Spectra identified as containing this phosphate neutral loss pattern could then be further interrogated by higher order MS^{N}, MSA, or some alternative activation approach.

In some aspects, the techniques described above can be used to identify major histocompatibility complex (MHC) peptides. MHC peptides are of great biological interest. From a research perspective, these molecules are a wonderful tool for providing insight into protein expression within the cell. From a clinical perspective, these peptides show incredible promise as an immunotherapy target. However, MHC peptides can be incredibly hard to identify, as these peptides tend to occur at low abundance and are the product of non-specific protein degradation.

To accommodate these non-specific enzymatic cleavages, MHC workflows often utilize multiple ion activation methods. In addition to standard energetic activation methods like CID and HCD, instrument operators often choose to interrogate potential MHC peptides by ETD and UVPD. These alternative fragmentation methods provide complimentary fragment ions (e.g., c- and z-type fragment ions to go with b- and y-type fragment ions), which greatly improve the confidence and sequence coverage of MHC peptide identifications. Furthermore, these alternative fragmentation methods have the added benefit of distinguishing isoleucine from leucine.

While these extra MS scans can add additional layers of information, this more comprehensive set of MS measurements can slow down the instrument quite a bit. Given a fixed analysis time, the depth of the analysis will be reduced if every MS1 feature in a sample is interrogated by HCD and UVPD.

MHC peptides have common motifs that correspond to the human leucocyte antigen (HLA) binding affinities. As such, these conserved MHC motifs make a good target for an error-tolerant real-time search (RTS) or real-time library search (RTLS) search. An MHC containing sample can be interrogated by mass spectrometry. MS1 features can first be interrogated using a fast HCD-type tandem mass spectrum. This mass spectrum can then be searched using an error-tolerant RTS or RTLS search that is based upon a database or spectral library of MHC motifs. If the error-tolerant RTS or RTLS search produces a match, an additional ETD or UVPD scan can be triggered. The technique can limit the number of MS1 features interrogated by all the necessary fragmentation scans to only those MS1 features that are likely to be MHC peptides.

In some aspects, the techniques described above can be used to trigger synchronous precursor selection (SPS) MS3 scans from MHC candidate spectra. Some quantitative MHC analyses utilize TMT labels. The acquisition of SPS MS3 scans can be limited to only MS2 spectra that produce a high confidence match to an MHC motif using the error-tolerant RTS/RTLS searching strategy described herein.

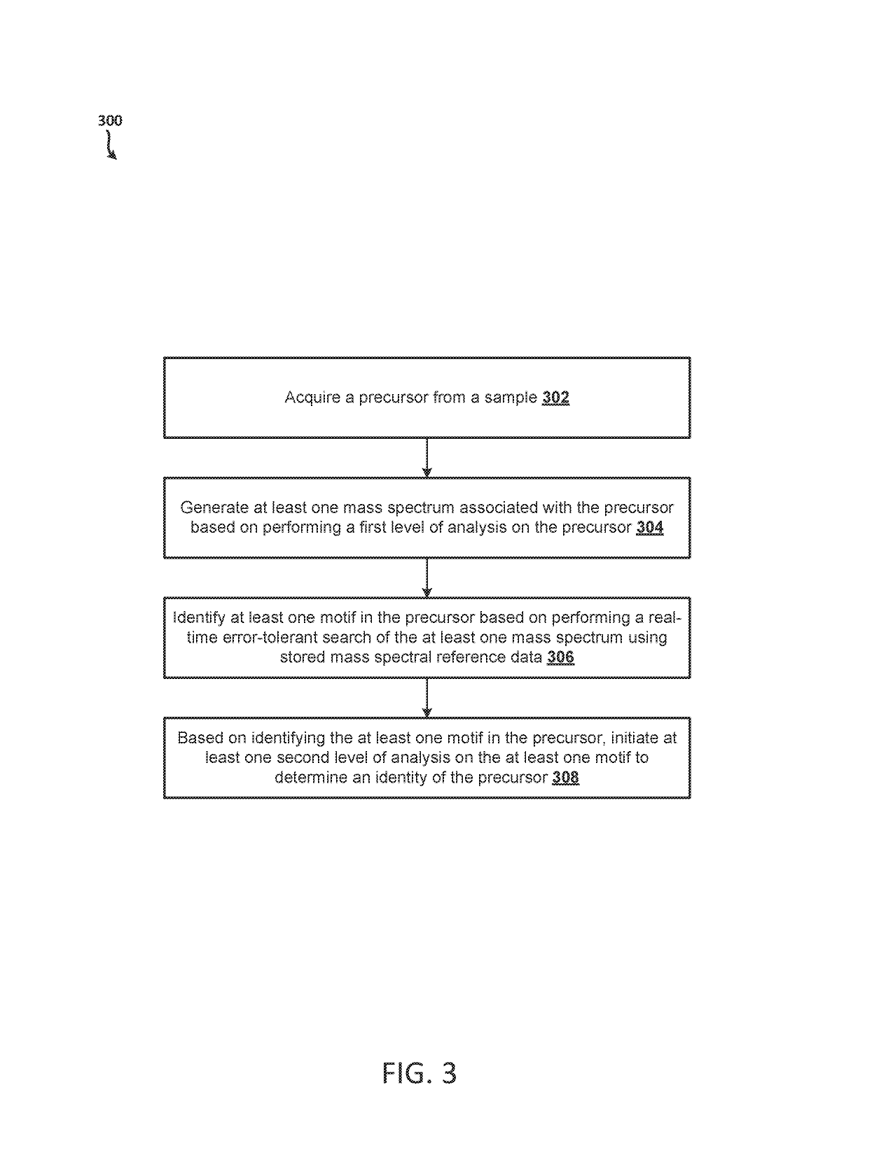

FIG. 3 is a flow diagram of an exemplary method 300 for error-tolerant real-time searching during mass spectrometry analysis of a sample, in accordance with various embodiments. The method 300 can be a computer-implemented method. For example, a computing device can include one or more processors and memory storing instructions that, when executed by the one or more processors, cause the device to perform the method 300. The method 300 can be used in any suitable setting to perform any suitable support operations. Operations are illustrated once each and in a particular order in FIG. 3, but the operations can be reordered and/or repeated as desired and appropriate. Different operations performed can be performed in parallel, as suitable.

At 302, a precursor can be acquired from a sample. The sample can be vaporized and ionized into precursor ions. The precursor ions can be any suitable type of ions to be analyzed, including small organic molecules, large organic molecules, biomolecules, DNA, RNA, proteins, peptides, fragments thereof, and/or the like.

At 304, at least one mass spectrum associated with the precursor can be generated. The at least one mass spectrum can be generated based on performing a first level of analysis on the precursor. The first level of analysis can include an MS1 scan and/or an MS2 scan. To perform the MS1 scan, a wide m/z range (e.g., full mass range) of the precursor ions can be analyzed to determine their mass to charge ratio and/or mass, i.e., to generate a MS1 spectra representative of the precursor ions. For example, to generate the first mass spectra, the precursor ions can be separated by mass and charge via electromagnetic deflection.

To perform the MS2 scan, ions from the first mass spectra can then be selectively fragmented and analyzed to generate a MS2 spectra for the ion fragments. A selected narrow m/z range of precursor ions can be fragmented, and the resulting fragment ions can be analyzed to determine their mass to charge ratio and/or mass, i.e., to generate the MS2 spectra representative of the fragmented ions. For example, to generate the MS2 spectra, the fragmented ions can be separated by mass and charge via electromagnetic deflection. The selected narrow m/z range of precursor ions can be fragmented by performing collisionally-induced fragmentation. Performing the collisionally-induced fragmentation can include performing any one or more of collision-induced dissociation (CID) or higher-energy collisional dissociation (HCD).

At 306, at least one motif in the precursor can be identified based on performing a real-time error-tolerant search of the at least one mass spectrum, i.e., the MS1 spectra and/or the MS2 spectra, using stored mass spectral reference data. The motif can include at least one of a sequence motif or a structural motif. The real-time error-tolerant search can be performed by comparing the second mass spectra to the stored mass spectral reference data. The mass spectral reference data can be stored, for example, in a database of references that is generated in silico and/or in a library of references that contains a collection of experimental spectra.

In aspects, the at least one mass spectrum can be transformed into a spectrum of mass differences. The at least one mass spectrum can be transformed into a spectrum of mass differences based on representing each pair of a plurality of pairs of fragment ions in the at least one mass spectrum as a single value defined by a mass difference between the fragment ions in the pair and an intensity of the fragment ions in the pair. If the at least one mass spectrum is transformed into the spectrum of mass differences, performing the real-time error-tolerant search of the at least one mass spectrum using the stored mass spectral reference data can include comparing the spectrum of mass differences to the stored mass spectral reference data.

At 308, at least one second level of analysis can be initiated based on identifying the at least one motif in the precursor. The at least one second level of analysis can be performed to determine an identity of the precursor. The at least one second level of analysis can include any one or more of an additional MS2 scan, an MS3 scan, an MS4 scan, or any other higher level MS^{N} scan. By performing the at least one second level of analysis only on the identified motif(s), instead of on all of the precursor, the precursor can still be identified with a high confidence, while also reducing the overall run time for the mass spectrometry analysis. This reduction in run time can be especially valuable given a fixed analysis time.

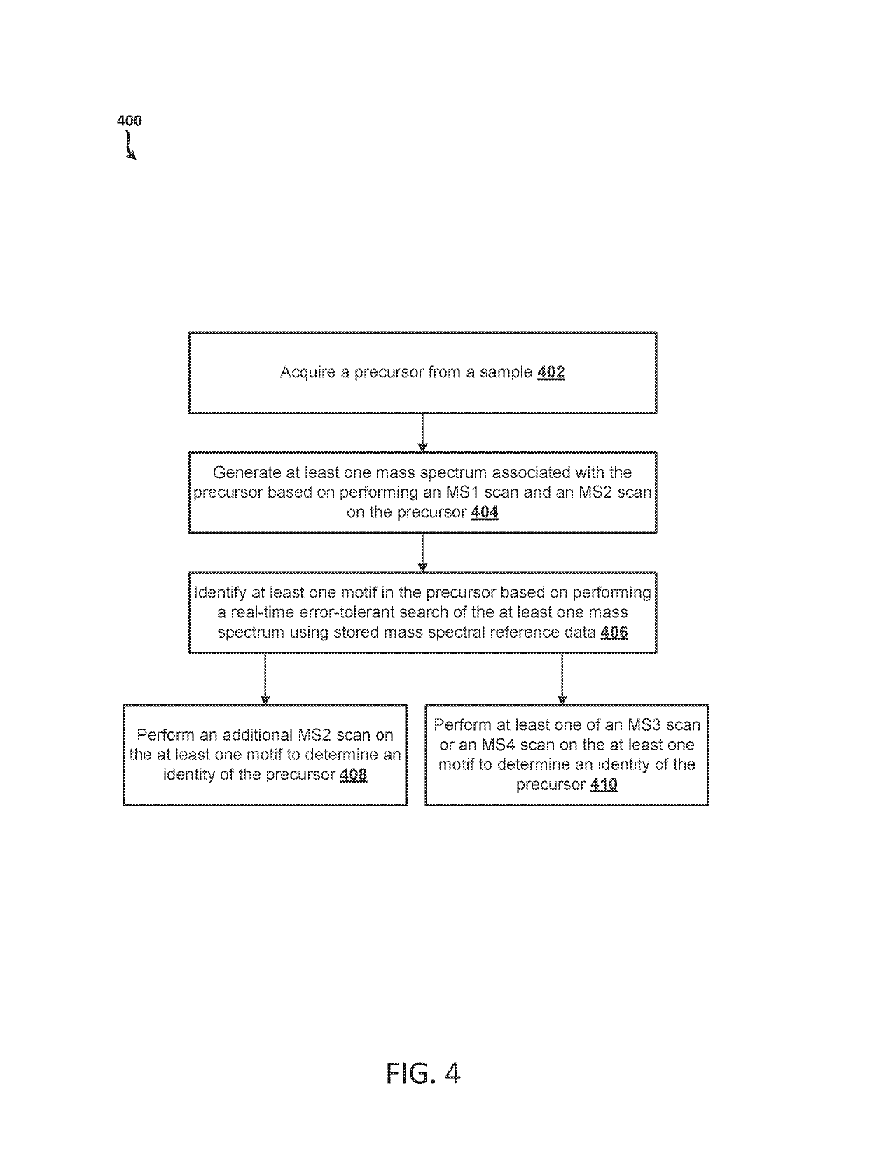

FIG. 4 is a flow diagram of an exemplary method 400 for error-tolerant real-time searching during mass spectrometry analysis of a sample, in accordance with various embodiments. The method 400 can be a computer-implemented method. For example, a computing device can include one or more processors and memory storing instructions that, when executed by the one or more processors, cause the device to perform the method 400. The method 400 can be used in any suitable setting to perform any suitable support operations. Operations are illustrated once each and in a particular order in FIG. 4, but the operations can be reordered and/or repeated as desired and appropriate. Different operations performed can be performed in parallel, as suitable.

At 402, a precursor can be acquired from a sample. The sample can be vaporized and ionized into precursor ions. The precursor ions can be any suitable type of ions to be analyzed, including small organic molecules, large organic molecules, biomolecules, DNA, RNA, proteins, peptides, fragments thereof, and/or the like.

At 404, at least one mass spectrum associated with the precursor can be generated. The at least one mass spectrum can be generated based on performing a first level of analysis on the precursor. The first level of analysis can include an MS1 scan and/or an MS2 scan. To perform the MS1 scan, a wide m/z range (e.g., full mass range) of the precursor ions can be analyzed to determine their mass to charge ratio and/or mass, i.e., to generate a MS1 spectra representative of the precursor ions. For example, to generate the first mass spectra, the precursor ions can be separated by mass and charge via electromagnetic deflection.

To perform the MS2 scan, ions from the first mass spectra can then be selectively fragmented and analyzed to generate a MS2 spectra for the ion fragments. A selected narrow m/z range of precursor ions can be fragmented, and the resulting fragment ions can be analyzed to determine their mass to charge ratio and/or mass, i.e., to generate the MS2 spectra representative of the fragmented ions. For example, to generate the MS2 spectra, the fragmented ions can be separated by mass and charge via electromagnetic deflection. The selected narrow m/z range of precursor ions can be fragmented by performing collisionally-induced fragmentation. Performing the collisionally-induced fragmentation can include performing any one or more of collision-induced dissociation (CID) or higher-energy collisional dissociation (HCD).

At 406, at least one motif in the precursor can be identified based on performing a real-time error-tolerant search of the at least one mass spectrum, i.e., the MS1 spectra and/or the MS2 spectra, using stored mass spectral reference data. The motif can include at least one of a sequence motif or a structural motif. The real-time error-tolerant search can be performed by comparing the second mass spectra to the stored mass spectral reference data. The mass spectral reference data can be stored, for example, in a database of references that is generated in silico and/or in a library of references that contains a collection of experimental spectra.

At least one second level of analysis can be initiated based on identifying the at least one motif in the precursor. The at least one second level of analysis can be performed to determine an identity of the precursor. At 408, an additional MS2 scan can be performed on the at least one motif to determine an identity of the precursor. The additional MS2 scan can utilize electron-mediated dissociation, proton-mediated dissociation, molecule-mediated dissociation, and/or photon-mediated dissociation. The additional MS2 can utilize any one or more of electron-transfer dissociation (ETD), proton transfer reaction (PTR), ultraviolet photodissociation (UVPD), or infrared multiple photon dissociation (IRMPD). Optionally, the additional MS2 scan be followed by one or more higher level scans, such as an MS3 scan, an MS4 scan, or any other higher level MS^{N} scan. At 410, at least one of an MS3 scan and an MS4 scan can be performed on the at least one motif to determine an identity of the precursor.

By performing the at least one second level of analysis only on the identified motif(s), instead of on all of the precursor, the precursor can still be identified with a high confidence, while also reducing the overall run time for the mass spectrometry analysis. This reduction in run time can be especially valuable given a fixed analysis time.

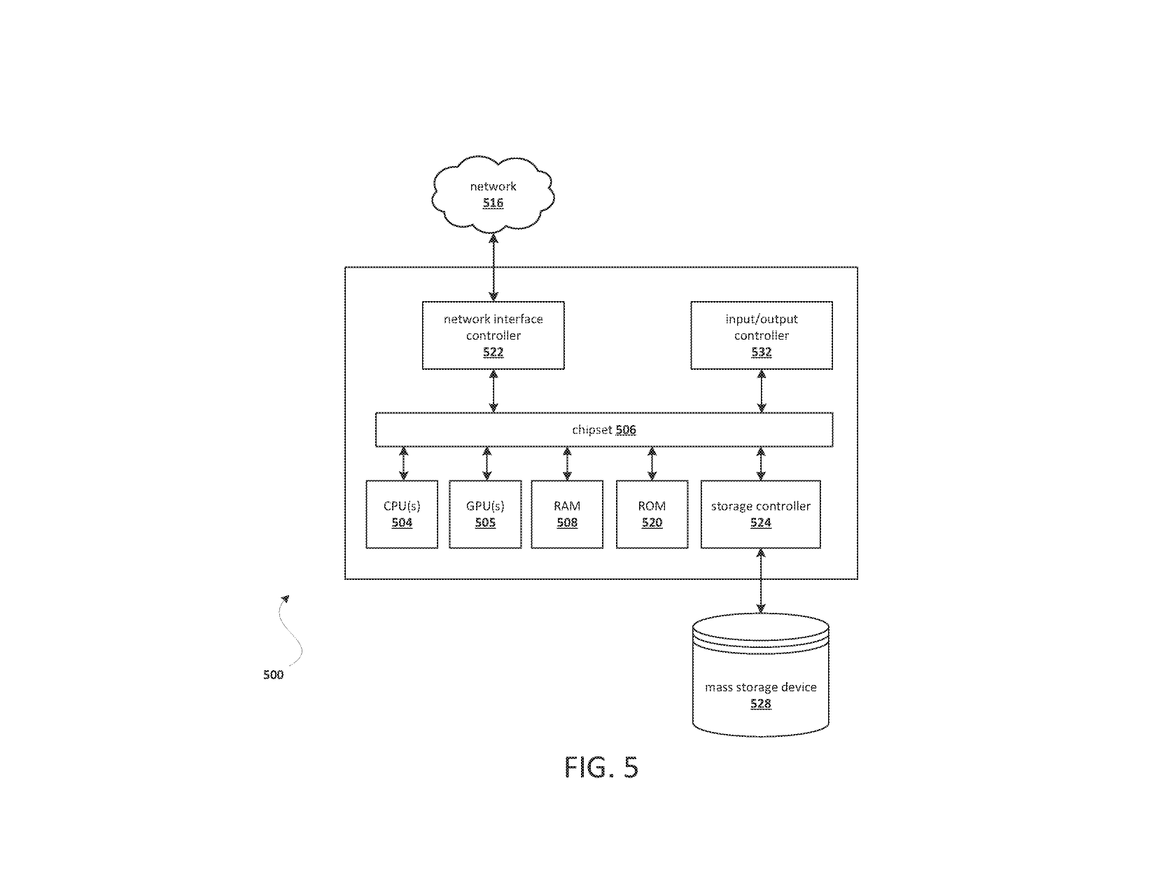

FIG. 5 depicts a computing device 500 that can be used in various aspects, such as the devices, components, or systems depicted in FIG. 1. Regarding the example architecture of FIG. 1, any of the components or devices can each be implemented in an instance of a computing device 500 of FIG. 5.

The computer architecture shown in FIG. 5 shows a conventional server computer, workstation, desktop computer, laptop, tablet, network appliance, PDA, e-reader, digital cellular phone, or other computing node, and can be utilized to execute any aspects of the computers described herein, such as to implement the methods described in relation to FIGS. 3-4.

The computing device 500 can include a baseboard, or “motherboard,” which is a printed circuit board to which a multitude of components or devices can be connected by way of a system bus or other electrical communication paths. One or more central processing units (CPUs) 504 can operate in conjunction with a chipset 506. The CPU(s) 504 can be standard programmable processors that perform arithmetic and logical operations necessary for the operation of the computing device 500.

The CPU(s) 504 can perform the necessary operations by transitioning from one discrete physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits including registers, adders-subtractors, arithmetic logic units, floating-point units, and the like.

The CPU(s) 504 can be augmented with or replaced by other processing units, such as GPU(s) 505. The GPU(s) 505 can comprise processing units specialized for but not necessarily limited to highly parallel computations, such as graphics and other visualization-related processing.

A chipset 506 can provide an interface between the CPU(s) 504 and the remainder of the components and devices on the baseboard. The chipset 506 can provide an interface to a random access memory (RAM) 508 used as the main memory in the computing device 500. The chipset 506 can further provide an interface to a computer-readable storage medium, such as a read-only memory (ROM) 520 or non-volatile RAM (NVRAM) (not shown), for storing basic routines that can help to start up the computing device 500 and to transfer information between the various components and devices. ROM 520 or NVRAM can also store other software components necessary for the operation of the computing device 500 in accordance with the aspects described herein.

The computing device 500 can operate in a networked environment using logical connections to remote computing nodes and computer systems through local area network (LAN) 516. The chipset 506 can include functionality for providing network connectivity through a network interface controller (NIC) 522, such as a gigabit Ethernet adapter. A NIC 522 can be capable of connecting the computing device 500 to other computing nodes over a network 516. It should be appreciated that multiple NICs 522 can be present in the computing device 500, connecting the computing device to other types of networks and remote computer systems.

The computing device 500 can be connected to a mass storage device 528 that provides non-volatile storage for the computer. The mass storage device 528 can store system programs, application programs, other program modules, and data, which have been described in greater detail herein. The mass storage device 528 can be connected to the computing device 500 through a storage controller 524 connected to the chipset 506. The mass storage device 528 can consist of one or more physical storage units. A storage controller 624 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 can store data on a mass storage device 528 by transforming the physical state of the physical storage units to reflect the information being stored. The specific transformation of a physical state can depend on various factors and on different implementations of this description. Examples of such factors can include, but are not limited to, the technology used to implement the physical storage units and whether the mass storage device 528 is characterized as primary or secondary storage and the like.

For example, the computing device 500 can store information to the mass storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 can further read information from the mass storage device 528 by detecting the physical states or characteristics of one or more particular locations within the physical storage units.

In addition to the mass storage device 528 described above, the computing device 500 can have access to other computer-readable storage media to store and retrieve information, such as program modules, data structures, or other data. It should be appreciated by those skilled in the art that computer-readable storage media can be any available media that provides for the storage of non-transitory data and that can be accessed by the computing device 500.

By way of example and not limitation, computer-readable storage media can include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

A mass storage device, such as the mass storage device 528 depicted in FIG. 5, can store an operating system utilized to control the operation of the computing device 500. The operating system can comprise a version of the LINUX operating system. The operating system can comprise a version of the WINDOWS SERVER operating system from the MICROSOFT Corporation. According to further aspects, the operating system can comprise a version of the UNIX operating system. Various mobile phone operating systems, such as IOS and ANDROID, can also be utilized. It should be appreciated that other operating systems can also be utilized. The mass storage device 528 can store other system or application programs and data utilized by the computing device 500.

The mass storage device 528 or other computer-readable storage media can also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described above. The computing device 500 can have access to computer-readable storage media storing computer-executable instructions, which, when executed by the computing device 500, can perform the methods described in relation to FIGS. 3-4.

A computing device, such as the computing device 500 depicted in FIG. 5, can also include an input/output controller 532 for receiving and processing input from a number of input devices, such as a keyboard, a mouse, a touchpad, a touch screen, an electronic stylus, or other type of input device. Similarly, an input/output controller 532 can provide output to a display, such as a computer monitor, a flat-panel display, a digital projector, a printer, a plotter, or other type of output device. It will be appreciated that the computing device 500 need not include all of the components shown in FIG. 5, can include other components that are not explicitly shown in FIG. 5, or can utilize an architecture completely different than that shown in FIG. 5.

As described herein, a computing device can be a physical computing device, such as the computing device 500 of FIG. 5. A computing node can also include a virtual machine host process and one or more virtual machine instances. Computer-executable instructions can be executed by the physical hardware of a computing device indirectly through interpretation and/or execution of instructions stored and executed in the context of a virtual machine.

The following Aspects are illustrative only and do not limit the scope of the present disclosure or the appended claims. Any part or parts of any one or more Aspects can be combined with any part or parts of any one or more other Aspects.

Aspect 1: A method comprising, consisting of, or consisting essentially of acquiring a precursor from the sample; generating at least one mass spectrum associated with the precursor based on performing a first level of analysis on the precursor; identifying at least one motif in the precursor based on performing a real-time error-tolerant search of the at least one mass spectrum using stored mass spectral reference data; and based on identifying the at least one motif in the precursor, initiating at least one second level of analysis on the at least one motif to determine an identity of the precursor.

Aspect 2: The method of Aspect 1, wherein performing the first level of analysis on the precursor comprises performing at least one of a MS1 and an MS2 scan on the precursor.

Aspect 3: The method of Aspect 1, wherein performing the first level of analysis on the precursor comprises performing collisionally-induced fragmentation on the precursor.

Aspect 4: The method of Aspect 3, wherein performing the collisionally-induced fragmentation on the precursor comprises performing any one or more of collision-induced dissociation (CID) or higher-energy collisional dissociation (HCD) on the precursor.

Aspect 5: The method of any one of Aspects 1-4, wherein the at least one second level of analysis comprises any one or more of an additional MS2 scan that utilizes electron-mediated dissociation, proton-mediated dissociation, molecule-mediated dissociation, or photon-mediated dissociation; an MS3 scan; an MS4 scan; or or any other higher level MS^{N} scan.

Aspect 6: The method of Aspect 5, wherein the additional MS2 scan utilizes any one or more of electron-transfer dissociation (ETD), proton transfer reaction (PTR), ultraviolet photodissociation (UVPD), or infrared multiple photon dissociation (IRMPD).

Aspect 7: The method of any one of Aspects 1-6, further comprising transforming the at least one mass spectrum into a spectrum of mass differences based on representing each pair of a plurality of pairs of fragment ions in the at least one mass spectrum as a single value defined by a mass difference between the fragment ions in the pair and an intensity of the fragment ions in the pair.

Aspect 8: The method of Aspect 7, wherein performing the real-time error-tolerant search of the at least one mass spectrum using the stored mass spectral reference data comprises comparing the spectrum of mass differences to the stored mass spectral reference data.

Aspect 9: The method of any one of Aspects 1-8, wherein the precursor comprises at least one of a peptide or a small molecule.

Aspect 10: The method of any one of Aspects 1-9, wherein the precursor comprises at least one of a peptide or a small molecule.

Aspect 11: The method of any one of Aspects 1-10, wherein the stored mass spectral reference data is stored in at least one of a database or a library.

Aspect 12: A mass spectrometry device, comprising, consisting of, or consisting essentially of one or more processors; and memory storing instructions that, when executed by the one or more processors, cause the mass spectrometry device to acquire a precursor from a sample; generate at least one mass spectrum associated with the precursor based on performing a first level of analysis on the precursor; identify at least one motif in the precursor based on performing a real-time error-tolerant search of the at least one mass spectrum using stored mass spectral reference data; and based on identifying the at least one motif in the precursor, initiate at least one second level of analysis on the at least one motif to determine an identity of the precursor.

Aspect 13: The mass spectrometry device of Aspect 12, wherein the instructions that, when executed by the one or more processors, cause the mass spectrometry device to perform the first level of analysis on the precursor cause the mass spectrometry device to perform at least one of a MS1 and an MS2 scan on the precursor.

Aspect 14: The mass spectrometry device of Aspect 12, wherein the instructions that, when executed by the one or more processors, cause the mass spectrometry device to perform the first level of analysis on the precursor cause the mass spectrometry device to perform collisionally-induced fragmentation on the precursor.

Aspect 15: The mass spectrometry device of Aspect 14, wherein the instructions that, when executed by the one or more processors, cause the mass spectrometry device to perform the collisionally-induced fragmentation on the precursor cause the mass spectrometry device to perform any one or more of collision-induced dissociation (CID) or higher-energy collisional dissociation (HCD) on the precursor.

Aspect 16: The mass spectrometry device of any one of Aspects 12-15, wherein the at least one second level of analysis comprises one or more of: an additional MS2 scan that utilizes electron-mediated dissociation, proton-mediated dissociation, molecule-mediated dissociation, or photon-mediated dissociation; an MS3 scan; or an MS4 scan.

Aspect 17: The mass spectrometry device of Aspect 16, wherein the additional MS2 scan utilizes any one or more of electron-transfer dissociation (ETD), proton transfer reaction (PTR), ultraviolet photodissociation (UVPD), or infrared multiple photon dissociation (IRMPD).

Aspect 18: The mass spectrometry device of any one of Aspects 12-17, wherein the instructions, when executed by the one or more processors, further cause the mass spectrometry device to: transform the at least one mass spectrum into a spectrum of mass differences based on reducing each pair of a plurality of pairs of fragment ions in the at least one mass spectrum to a single peak defined by a mass difference between the fragment ions in the pair and an intensity of the fragment ions in the pair.

Aspect 19: The mass spectrometry device of Aspect 18, wherein the instructions that, when executed by the one or more processors, cause the mass spectrometry device to perform the real-time error-tolerant search of the at least one mass spectrum using the stored mass spectral reference data cause the mass spectrometry device to compare the spectrum of mass differences to the stored mass spectral reference data.

Aspect 20: The mass spectrometry device of any one of Aspects 12-19, wherein the precursor comprises one of a peptide or a small molecule.

Aspect 21: The mass spectrometry device of any one of Aspects 12-20, wherein the motif comprises at least one of a sequence motif or a structural motif.

Aspect 22: The mass spectrometry device of any one of Aspects 12-21, wherein the stored mass spectral reference data is stored in at least one of a database or a library.

Aspect 23: A computer-readable medium storing instructions that, when executed, cause acquiring a precursor from a sample; generating at least one mass spectrum associated with the precursor based on performing a first level of analysis on the precursor; identifying at least one motif in the precursor based on performing a real-time error-tolerant search of the at least one mass spectrum using stored mass spectral reference data; and based on identifying the at least one motif in the precursor, initiating at least one second level of analysis on the at least one motif to determine an identity of the precursor.

Aspect 24: The computer-readable medium of Aspect 23, wherein performing the first level of analysis on the precursor comprises performing at least one of a MS1 and an MS2 scan on the precursor.

Aspect 25: The computer-readable medium of Aspect 23, wherein performing the first level of analysis on the precursor comprises performing collisionally-induced fragmentation on the precursor.

Aspect 26: The computer-readable medium of Aspect 25, wherein performing the collisionally-induced fragmentation on the precursor comprises performing any one or more of collision-induced dissociation (CID) or higher-energy collisional dissociation (HCD) on the precursor.

Aspect 27: The computer-readable medium of any one of Aspects 23-26, wherein the at least one second level of analysis comprises one or more of an additional MS2 scan that utilizes electron-mediated dissociation, proton-mediated dissociation, molecule-mediated dissociation, or photon-mediated dissociation; an MS3 scan; or an MS4 scan.

Aspect 28: The computer-readable medium of Aspect 27, wherein the additional MS2 scan utilizes any one or more of electron-transfer dissociation (ETD), proton transfer reaction (PTR), ultraviolet photodissociation (UVPD), or infrared multiple photon dissociation (IRMPD).

Aspect 29: The computer-readable medium of any one of Aspects 23-28, wherein the instructions, when executed, further cause transforming the at least one mass spectrum into a spectrum of mass differences based on reducing each pair of a plurality of pairs of fragment ions in the at least one mass spectrum to a single peak defined by a mass difference between the fragment ions in the pair and an intensity of the fragment ions in the pair.

Aspect 30: The computer-readable medium of Aspect 29, wherein performing the real-time error-tolerant search of the at least one mass spectrum using the stored mass spectral reference data comprises comparing the spectrum of mass differences to the stored mass spectral reference data.

Aspect 31: The computer-readable medium of any one of Aspects 23-30, wherein the precursor comprises one of a peptide or a small molecule.

Aspect 32: The computer-readable medium of any one of Aspects 23-31, wherein the motif comprises at least one of a sequence motif or a structural motif.

Aspect 33: The computer-readable medium of any one of Aspects 23-32, wherein the stored mass spectral reference data is stored in at least one of a database or a library.

In the above detailed description, reference is made to the accompanying drawings that form a part hereof wherein like numerals designate like parts throughout, and in which is shown, by way of illustration, embodiments that can be practiced. It is to be understood that other embodiments can be utilized, and structural or logical changes can be made, without departing from the scope of the present disclosure. Therefore, the detailed description is not to be taken in a limiting sense.

Various operations can be described as multiple discrete actions or operations in turn, in a manner that is most helpful in understanding the subject matter disclosed herein. The order of description, however, should not be construed as to imply that these operations are necessarily order dependent. In particular, these operations need not be performed in the order of presentation. Operations described can be performed in a different order from the described embodiment. Various additional operations can be performed, and/or described operations can be omitted in additional embodiments.

For the purposes of the present disclosure, the phrases "A and/or B" and "A or B" mean (A), (B), or (A and B). For the purposes of the present disclosure, the phrases "A, B, and/or C" and "A, B, or C" mean (A), (B), (C), (A and B), (A and C), (B and C), or (A, B, and C). Although some elements can be referred to in the singular, such as “a processing device”, any appropriate elements can be represented by multiple instances of that element, and vice versa. For example, a set of operations described as performed by a processing device can be implemented with different ones of the operations performed by different processing devices.

The description uses the phrases "an embodiment," “various embodiments,” and "some embodiments," each of which can refer to one or more of the same or different embodiments. Furthermore, the terms "comprising," "including," "having," and the like, as used with respect to embodiments of the present disclosure, are synonymous. When used to describe a range of dimensions, the phrase "between X and Y" represents a range that includes X and Y. As used herein, an “apparatus” can refer to any individual device, collection of devices, part of a device, or collections of parts of devices. The drawings are not necessarily to scale.

What is claimed:

1. A method of analyzing a sample by mass spectrometry, the method comprising:
acquiring a precursor from the sample;
generating at least one mass spectrum associated with the precursor based on performing a first level of analysis on the precursor;
identifying at least one motif in the precursor based on performing a real-time error-tolerant search of the at least one mass spectrum using stored mass spectral reference data; and
based on identifying the at least one motif in the precursor, initiating at least one second level of analysis on the at least one motif to determine an identity of the precursor.

2. The method of claim 1, wherein performing the first level of analysis on the precursor comprises performing at least one of a MS1 and an MS2 scan on the precursor.

3. The method of claim 1, wherein performing the first level of analysis on the precursor comprises performing collisionally-induced fragmentation on the precursor.

4. The method of claim 3, wherein performing the collisionally-induced fragmentation on the precursor comprises performing any one or more of collision-induced dissociation (CID) or higher-energy collisional dissociation (HCD) on the precursor.

5. The method of claim 1, wherein the at least one second level of analysis comprises any one or more of:
an additional MS2 scan that utilizes electron-mediated dissociation, proton-mediated dissociation, molecule-mediated dissociation, or photon-mediated dissociation;
an MS3 scan; or
an MS4 scan.

6. The method of claim 5, wherein the additional MS2 scan utilizes any one or more of electron-transfer dissociation (ETD), proton transfer reaction (PTR), ultraviolet photodissociation (UVPD), or infrared multiple photon dissociation (IRMPD).

7. The method of claim 1, further comprising:
transforming the at least one mass spectrum into a spectrum of mass differences based on representing each pair of a plurality of pairs of fragment ions in the at least one mass spectrum as a single value defined by a mass difference between the fragment ions in the pair and an intensity of the fragment ions in the pair.

8. The method of claim 7, wherein performing the real-time error-tolerant search of the at least one mass spectrum using the stored mass spectral reference data comprises comparing the spectrum of mass differences to the stored mass spectral reference data.

9. The method of claim 1, wherein the precursor comprises at least one of a peptide or a small molecule.

10. The method of claim 1, wherein the motif comprises at least one of a sequence motif or a structural motif.

11. The method of claim 1, wherein the stored mass spectral reference data is stored in at least one of a database or a library.

12. A mass spectrometry device, comprising:
one or more processors; and
memory storing instructions that, when executed by the one or more processors, cause the mass spectrometry device to:
acquire a precursor from a sample;
generate at least one mass spectrum associated with the precursor based on performing a first level of analysis on the precursor;
identify at least one motif in the precursor based on performing a real-time error-tolerant search of the at least one mass spectrum using stored mass spectral reference data; and
based on identifying the at least one motif in the precursor, initiate at least one second level of analysis on the at least one motif to determine an identity of the precursor.

13. The mass spectrometry device of claim 12, wherein the instructions that, when executed by the one or more processors, cause the mass spectrometry device to perform the first level of analysis on the precursor cause the mass spectrometry device to perform at least one of an MS1 and an MS2 scan on the precursor.

14. The mass spectrometry device of claim 12, wherein the instructions that, when executed by the one or more processors, cause the mass spectrometry device to perform the first level of analysis on the precursor cause the mass spectrometry device to perform collisionally-induced fragmentation on the precursor.

15. The mass spectrometry device of claim 12, wherein the at least one second level of analysis comprises one or more of:
an additional MS2 scan that utilizes electron-mediated dissociation, proton-mediated dissociation, molecule-mediated dissociation, or photon-mediated dissociation;
an MS3 scan; or
an MS4 scan.

16. The mass spectrometry device of claim 12, wherein the instructions, when executed by the one or more processors, further cause the mass spectrometry device to:
transform the at least one mass spectrum into a spectrum of mass differences based on reducing each pair of a plurality of pairs of fragment ions in the at least one mass spectrum to a single peak defined by a mass difference between the fragment ions in the pair and an intensity of the fragment ions in the pair.

17. The mass spectrometry device of claim 16, wherein the instructions that, when executed by the one or more processors, cause the mass spectrometry device to perform the real-time error-tolerant search of the at least one mass spectrum using the stored mass spectral reference data cause the mass spectrometry device to compare the spectrum of mass differences to the stored mass spectral reference data.

18. The mass spectrometry device of claim 12, wherein the motif comprises at least one of a sequence motif or a structural motif.

19. A computer-readable medium storing instructions that, when executed, cause:
acquiring a precursor from a sample;
generating at least one mass spectrum associated with the precursor based on performing a first level of analysis on the precursor;
identifying at least one motif in the precursor based on performing a real-time error-tolerant search of the at least one mass spectrum using stored mass spectral reference data; and
based on identifying the at least one motif in the precursor, initiating at least one second level of analysis on the at least one motif to determine an identity of the precursor.

20. The computer-readable medium of claim 19, wherein performing the first level of analysis on the precursor comprises performing at least one of a MS1 and an MS2 scan on the precursor, and wherein the at least one second level of analysis comprises one or more of:
an additional MS2 scan that utilizes electron-mediated dissociation, proton-mediated dissociation, molecule-mediated dissociation, or photon-mediated dissociation;
an MS3 scan; or
an MS4 scan.
